(19) United States
(12) Patent Application Publication
(10) Pub. No.: US 2023/0114691 A1
(43) Pub. Date: Apr. 13, 2023

(54) U-BOLT MOUNTING JIG AND U-BOLT MOUNTING METHOD

(71) Applicant: NIPPON TELEGRAPH AND TELEPHONE CORPORATION, Tokyo (JP)

(72) Inventors: Daiki KOBAYASHI, Tokyo (JP); Yuta IKEGUCHI, Tokyo (JP); Masafumi NAKAGAWA, Tokyo (JP); Atsushi ARATAKE, Tokyo (JP)

(73) Assignee: NIPPON TELEGRAPH AND TELEPHONE CORPORATION, Tokyo (JP)

(21) Appl. No.: 17/911,986

(22) PCT Filed: Mar. 18, 2020
(86) PCT No.: PCT/JP2020/012103

§ 371 Date: Sep. 15, 2022

(51) Int. Cl. F16L 3/04

(52) U.S. Cl. CPC F16L 3/04

(57) ABSTRACT

A U-bolt installation jig (100) includes: a first fixing member (101a) and a second fixing member (101b) opposing each other, with a predetermined spacing therebetween, while being perpendicular to an attachment member (300) , the first and second fixing members being brought into contact with side portions of a U-bolt (20); a stretchable member (102) fitted to the first fixing member (101a) and the second fixing member (101b) while being parallel to the attachment member (300), the stretchable member being brought into contact with a center portion of the U-bolt (20); and a first joint member (103a) and a second joint member (103b) joined to the first fixing member (101a) and the second fixing member (101b) , the first and second joint members sandwiching the first fixing member (101a) and the second fixing member (101b) to finely adjust the predetermined spacing.

### TECHNICAL FIELD

The present disclosure relates to a U-bolt installation jig and a U-bolt installation method.

### BACKGROUND ART

It is conventionally known that U-bolts are used to fix a conduit to an attachment member that is attached to a structure such as a bridge. For example, PTL 1 discloses a U-bolt structure that is provided with a U-bolt for fixing a pipe to a frame, and a saddle that includes a first support portion for supporting the pipe and a second support portion arranged between the pipe and the frame, thereby improving the support rigidity and load capacity and enabling fine adjustment of the saddle.

### CITATION LIST

### Patent Literature

[PTL 1] JP 2016-056812A

### SUMMARY OF THE INVENTION

### Technical Problem

A bolt hole into which the U-bolt is inserted is made larger than the diameter of the U-bolt. If, for example, a U-bolt with a diameter of 9 mm, such as that shown in FIG. 6B, is inserted into a bolt hole that is 30 millimeters long in the lengthwise direction and 15 millimeters long in the widthwise direction, such as that shown in FIG. 6A, a remaining space with a length of 10.5 millimeters is formed at each end in the lengthwise direction of the U-bolt, and a remaining space with a length of three millimeters is formed at each end in the widthwise direction of the U-bolt.

When fastening nuts to a U-bolt, an operator usually fastens a nut on one side at a time. For this reason, if remaining spaces are formed in the bolt holes, as shown in FIG. 7, a U-bolt 20A may be obliquely installed onto a member 300A. Further, the U-bolt structure described in PTL 1 has many components, which leads to more cost and installation work, and difficulty in maintenance.

In view of the foregoing, an object of the present disclosure is to provide a U-bolt installation jig and a U-bolt installation method that enable a U-bolt to be perpendicularly installed onto a member without increasing the number of components.

### Means for Solving the Problem

A U-bolt installation jig according to one embodiment is a U-bolt installation jig for installing a U-bolt for fixing a conduit to a member, the jig including: a first fixing member and a second fixing member opposing each other with a predetermined spacing therebetween while being perpendicular to the member, the first and second fixing members being brought into contact with side portions of the U-bolt; a stretchable member fitted to the first fixing member and the second fixing member while being parallel to the member, the stretchable member being brought into contact with a center portion of the U-bolt; and a first joint member and a second joint member joined to the first fixing member and the second fixing member, the first and second joint members sandwiching the first fixing member and the second fixing member to finely adjust the predetermined spacing.

A U-bolt installation method according to one embodiment is a U-bolt installation method for installing a U-bolt for fixing a conduit to a member, the method including: fixing a first fixing member and a second fixing member, with a predetermined spacing therebetween, to the member such that the first fixing member and the second fixing member are perpendicular to the member; providing the U-bolt to the member such that side portions of the U-bolt come into contact with the first fixing member and the second fixing member; fitting a stretchable member to the first fixing member and the second fixing member such that the stretchable member is parallel to the member; sliding the stretchable member such that the stretchable member comes into contact with a center portion of the U-bolt; joining a first joint member and a second joint member to the first fixing member and the second fixing member and finely adjusting the predetermined spacing; fastening a nut to the U-bolt; removing the first joint member and the second joint member from the second fixing member; and removing the first fixing member joined to the first joint member and the second joint member, the second fixing member, and the stretchable member from the member.

### Effects of the Invention

According to the present disclosure, it is possible to provide a U-bolt installation jig and a U-bolt installation method that enable a U-bolt to be perpendicularly installed onto a member without increasing the number of components.

### BRIEF DESCRIPTION OF DRAWINGS

FIG. 1A is a side view showing an example of a configuration of a U-bolt installation jig according to one embodiment.

FIG. 1B is a plan view showing an example of a configuration of the U-bolt installation jig according to one embodiment.

FIG. 2 is a flowchart showing an example of a U-bolt installation method according to one embodiment.

FIG. 3A shows an example of the U-bolt installation method according to one embodiment.

FIG. 3B shows an example of the U-bolt installation method according to one embodiment.

FIG. 3C shows an example of the U-bolt installation method according to one embodiment.

FIG. 3D shows an example of the U-bolt installation method according to one embodiment.

FIG. 3E shows an example of the U-bolt installation method according to one embodiment.

FIG. 3F shows an example of the U-bolt installation method according to one embodiment.

FIG. 3G shows an example of the U-bolt installation method according to one embodiment.

FIG. 4 is a side view showing an example of a configuration of a U-bolt installation jig according to a variation 1.

FIG. 5 is a side view showing an example of a configuration of a U-bolt installation jig according to a variation 2.

FIG. 6A is a plan view showing an example of a bolt hole.

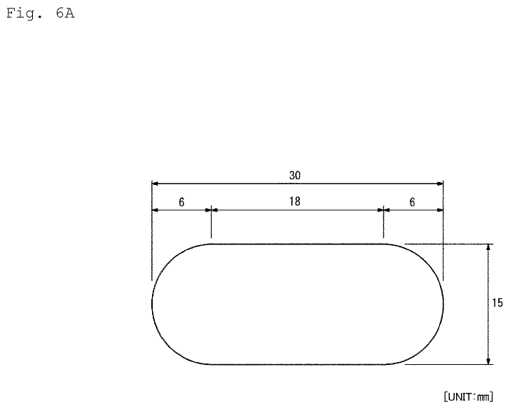

FIG. 6B is a plan view showing an example of the relationship between the diameter of a U-bolt and the bolt hole.

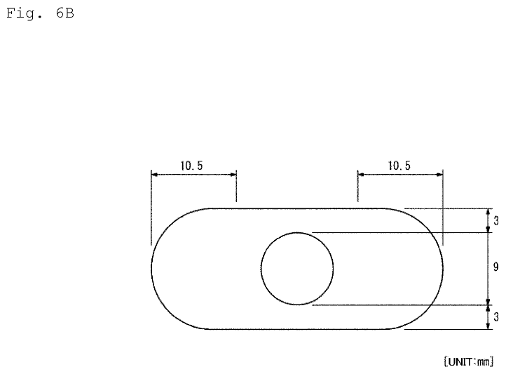

FIG. 7 is a side view showing an example of a U-bolt that is obliquely installed onto a member.

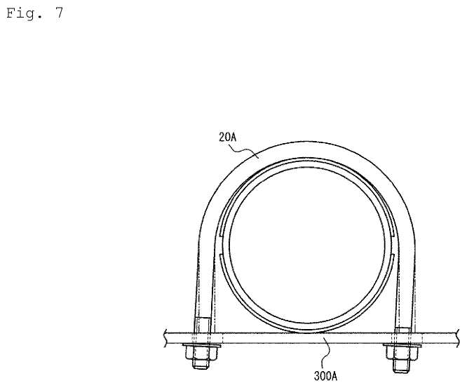

### DESCRIPTION OF EMBODIMENTS

Modes for carrying out the present invention will be described below with reference to the drawings.

In the present specification, “a U-bolt being perpendicular to a member” means that side portions of the U-bolt are arranged closer to the member than to the center of the U-bolt, and that a straight line connecting two end portions of the U-bolt is parallel to the surface of the member. “A U-bolt being oblique with respect to a member” means that a straight line connecting two end portions of the U-bolt is inclined with respect to the surface of the member.

In the present specification, “upper”, “lower”, and “perpendicular” mean directions parallel to a Z-axis of the coordinate axes shown in the drawings, and “parallel” means a direction parallel to an XY plane of the coordinate axes shown in the drawings.

<Configuration of U-Bolt Installation Jig>

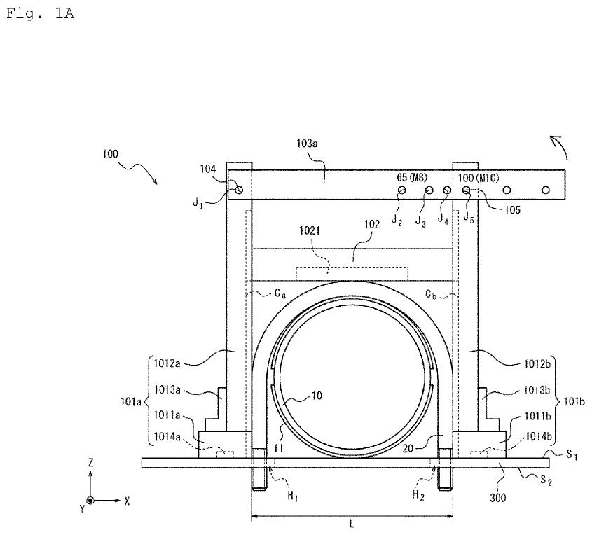

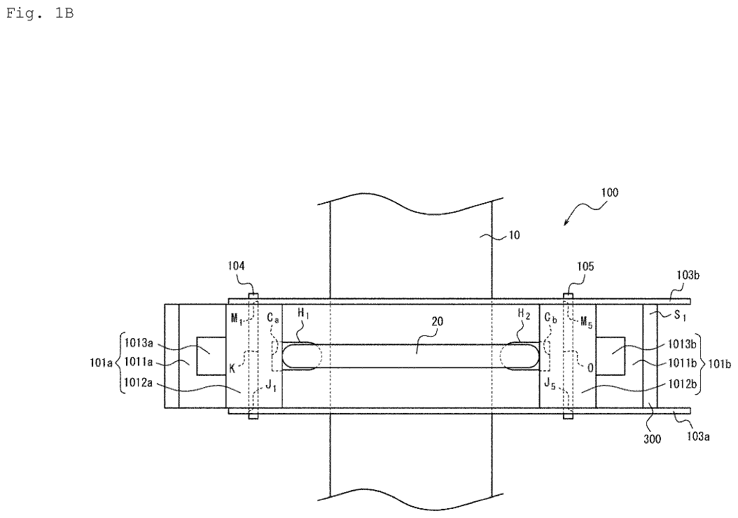

A configuration of a U-bolt installation jig 100 according to the present embodiment will be described with reference to FIGS. 1A and 1B. FIG. 1A is a side view showing an example of a configuration of a U-bolt installation jig 100. FIG. 1B is a plan view showing an example of a configuration of the U-bolt installation jig 100. Note that FIG. 1B omits a stretchable member 102 shown in FIG. 1A.

The U-bolt installation jig 100 is for installing a U-bolt 20 for fixing a conduit 10 onto an attachment member 300 that is attached to a structure.

The attachment member 300 need only have a flat surface S₁ and be capable of stably supporting the conduit 10. The attachment member 300 is made of, for example, L-shaped steel, flat steel, H-shaped steel, or the like. The attachment member 300 has a bolt hole H₁ into which one end of the U-bolt 20 is inserted, and a bolt hole H₂ into which the other end of the U-bolt 20 is inserted.

The conduit 10 is a resin or metal pipe, such as a hard vinyl pipe, an FRP (Fiber Reinforced Plastics) pipe, a steel pipe, or an FRPM (Fiberglass Reinforced Plastic Mortar) pipe. The conduit 10 need only have a cylindrical shape, and its configuration is not specifically limited. For example, the conduit 10 may have a joint and an uneven outer portion. For example, the conduit 10 may have a protective piece 11 adhered using an adhesive on its outer portion (see FIG. 1A). The conduit 10 including the protective piece 11 enables the conduit 10 to be protected when the conduit 10 is fixed to the attachment member 300 using the U-bolt 20. Although FIG. 1 shows as an example the case where one conduit 10 is installed onto the attachment member 300, the number of conduits 10 to be installed onto the attachment member 300 is not specifically limited.

The U-bolt 20 is a single steel material that has a center portion having a curved shape, linear side portions, and two end portions having a bolt structure. The two end portions of the U-bolt 20 are inserted into the bolt hole H₁ and the bolt hole H₂ and screw with nuts via the conduit 10, the attachment member 300, and washers. The conduit 10 is thus fixed to the attachment member 300.

The U-bolt installation jig 100 will be described below in detail.

The U-bolt installation jig 100 includes a fixing member (first fixing member) 101a, a fixing member (second fixing member) 101b, a stretchable member 102, a joint member (first joint member) 103a, a joint member (second joint member) 103b, a stop member (first stop member) 104, and a stop member (second stop member) 105. The fixing member 101a includes a fixing portion 1011a, a branch portion 1012a, and a reinforcing portion 1013a. The fixing member 101b includes a fixing portion 1011b, a branch portion 1012b, and a reinforcing portion 1013b.

The fixing members 101a and 101b are fixed, with a spacing L between them, to the attachment member 300 so as to be perpendicular to the attachment member 300. The fixing members 101a and 101b have respective slide grooves Ca and Cb. The slide grooves Ca and Cb are brought into contact with respective side portions of the U-bolt 20. The spacing L is not specifically limited, and is adjusted as appropriate by an operator based on the nominal size of the U-bolt 20, for example. Although the side portions of the U-bolts 20 are in contact with end portions of the respective fixing members 101a and 101b in the figure, the side portions of the U-bolt 20 may alternatively be fitted into the respective slide grooves Ca and Cb.

For the details of the nominal size of the U-bolt 20, for example, the following literature can be referred to.

“U-bolt Specifications and Size Tables”, Sudou Co., Ltd.

It is preferable that the fixing portions 1011a and the 1011b include respective internally embedded magnets 1014a and 1014b. The fixing portions 1011a and 1011b having the magnets 1014a and 1014b enable the fixing portions 1011a and 1011b to be firmly fixed to the attachment member 300. This configuration saves the operator conducting work such as manually holding the fixing portions 1011a and 1011b, making it possible to avoid inconvenience that the operator is using both hands and it is difficult for him to conduct the work.

The branch portions 1012a and 1012b are joined to the respective fixing portions 1011a and 1011b. The method for joining the branch portions 1012a and 1012b to the fixing portions 1011a and 1011b is not specifically limited. For example, any known method such as bolting, welding, or adhesive bonding is employed for the bonding.

An open hole K is provided in the branch portion 1012a (see FIG. 1B). The branch portion 1012a is joined to the joint members 103a and 103b via a stop member 104, which is inserted into the open hole K.

An open hole O is provided in the branch portion 1012b (see FIG. 1B). The branch portion 1012a is joined to the joint members 103a and 103b via a stop member 105, which is inserted into the open hole O.

The reinforcing portion 1013a is joined to the fixing portion 1011a and the branch portion 1012a, and reinforces the fixing portion 1011a and the branch portion 1012a. The reinforcing portion 1013b is joined to the fixing portion 1011b and the branch portion 1012b, and reinforces the fixing portion 1011b and the branch portion 1012b. The reinforcing portions 1013a and 1013b are each L-shaped, and are joined on one face side to the respective fixing portions 1011a and 1011b and joined on the other face side to the respective branch portions 1012a and 1012b. The method for joining the reinforcing portion 1013a to the fixing portion 1011a and the branch portion 1012a and the method for joining the reinforcing portion 1013b to the fixing portion 1011b and the branch portion 1012b are not specifically limited. For example, any known method such as bolting, welding, or adhesive bonding is employed for the joining.

The stretchable member 102 has one end fitted into the slide groove Ca provided in the fixing member 101a and the other end fitted into the slide groove Cb provided in the fixing member 101b such that the stretchable member 102 is parallel to the attachment member 300. The stretchable member 102 is provided such that it is in contact with the center portion of the U-bolt 20.

The stretchable member 102 is capable of moving up and down in the Z-axis direction along the slide grooves Ca and Cb. This configuration enables an upper portion of the U-bolt 20 to be fixed to the U-bolt installation jig 100 such that the U-bolt 20 is perpendicular to the attachment member 300, in accordance with the size (height) of the U-bolt 20.

The stretchable member 102 is capable of stretching and contracting in the X-axis direction in accordance with the spacing L between the fixing members 101a and 101b. The stretchable member 102 is, for example, a telescopic pole used in an antenna. The telescopic pole includes a plurality of tubular pole members, and each pole member is fitted to each other along so as to be capable of sliding along the center axis of the tube. The configuration of the stretchable member 102 is not specifically limited.

It is preferable that the stretchable member 102 has a groove extending along the curved shape of the center portion of the U-bolt 20, at a position at which the stretchable member 102 is in contact with the center portion of the U-bolt 20. The stretchable member 102 having this groove enables the U-bolt 20 to be stably kept perpendicular to the attachment member 300. That is, the U-bolt 20 can be kept from becoming oblique with respect to the attachment member 300.

It is preferable that the stretchable member 102 includes an internally embedded magnet 1021. The stretchable member 102 including the magnet 1021 enables the stretchable member 102 to be firmly fixed to the U-bolt 20. The U-bolt 20 can be thus stably kept perpendicular to the attachment member 300. That is, the U-bolt 20 can be kept from becoming oblique with respect to the attachment member 300.

The joint members 103a and 103b are joined to the respective fixing members 101a and 101b, and finely adjust the spacing L between the fixing members 101a and 101b. The joint members 103a and 103b are, for example, metal fittings.

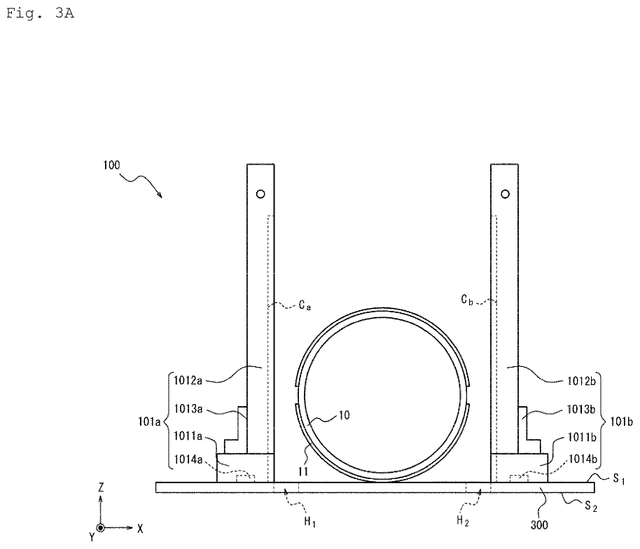

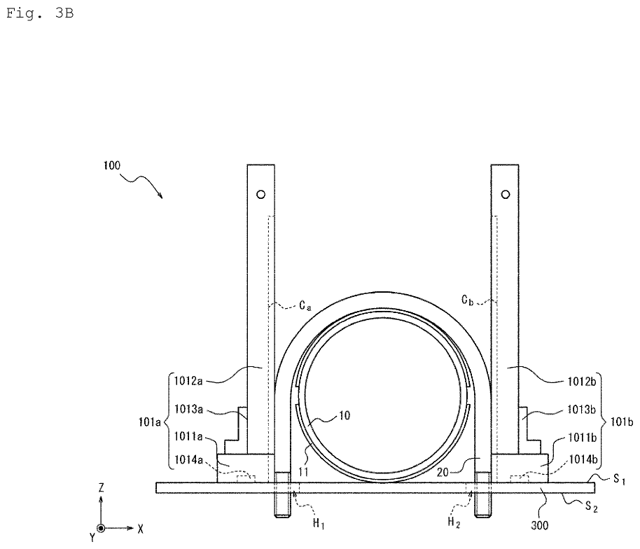

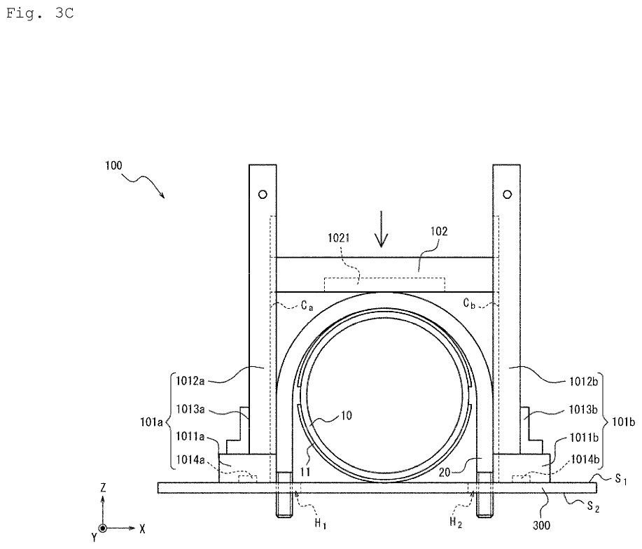

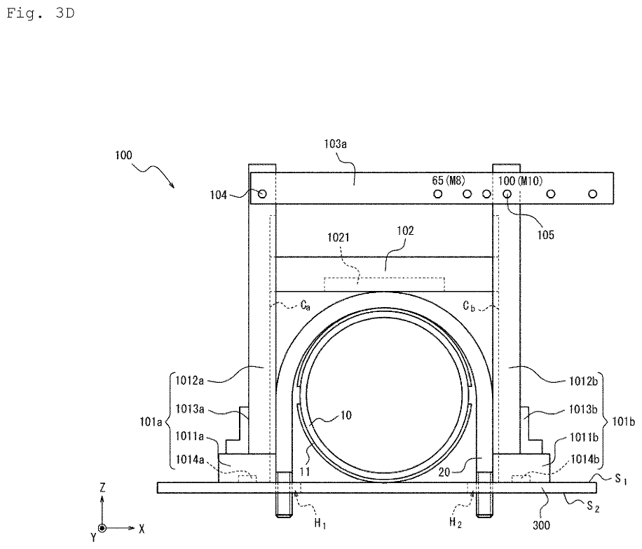

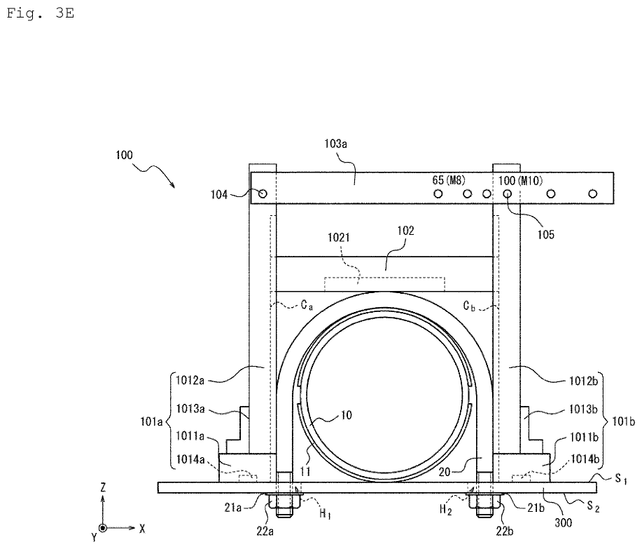

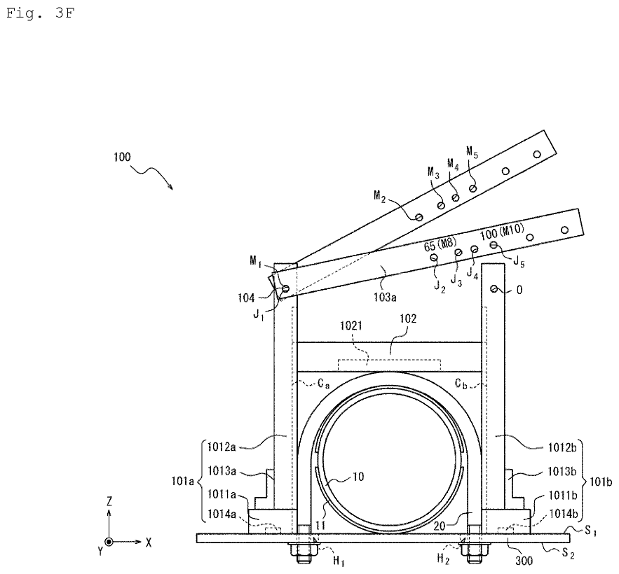

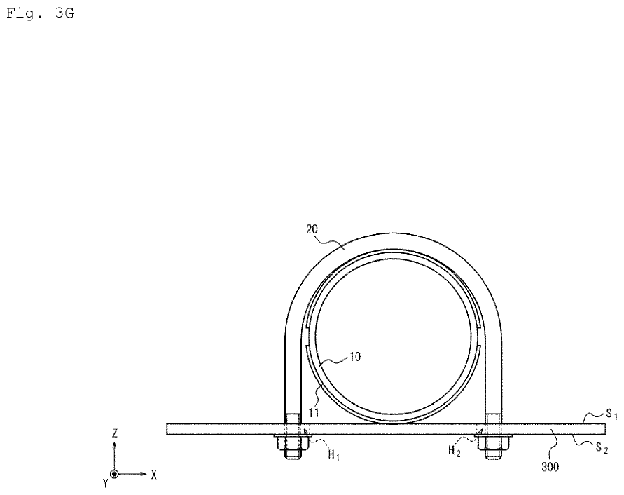

The joint member 103a is provided with a plurality of open holes Jₙ (n≥2) (see FIG. 3F). Specifically, an open hole J₁ is provided on one end side of the joint member 103a, and open holes J₂ to Jₙ are provided on the other end side of the joint member 103a. The stop member 104 is inserted into the open hole J₁. The stop member 105 is inserted into one of the open holes J₂ to Jₙ. The joint member 103a is joined to the fixing members 101a and 101b via the stop member 104 that is inserted into the open holes J₁ and K, and the stop member 105 that is inserted into one of the open holes J₂ to Jₙ and the open hole O.

The joint member 103b is provided with a plurality of open holes Mₙ (n≥2) (see FIG. 3F). Specifically, an open hole M₁ is provided on one end side of the joint member 103b, and open holes M₂ to Mₙ are provided on the other end side of the joint member 103b. The stop member 104 is inserted into the open hole M. The stop member 105 is inserted into one of the open holes M₂ to Mₙ. The joint member 103b is joined to the fixing members 101a and 101b via the stop member 104 that is inserted into the open hole M₁ and K, and the stop member 105 that is inserted into one of the open holes M₂ to Mₙ and the open hole O.

The plurality of open holes Jₙ and the plurality of open holes Mₙ are provided in correspondence with the nominal size of the U-bolt 20.

If, for example, the nominal size of the U-bolt 20 is “65 (M8)”, the joint member 103a is provided with the open holes J₁ and J₂, and the joint member 103b is provided with the open holes M₁ and M₂. That is to say, the open holes are provided such that the spacing L between the fixing members 101a and 101b matches the size (width) of the “65 (M8)” U-bolt. The stop member 104 is inserted into the open holes J₁, K, and M₁, and the stop member 105 is inserted into the open holes J₂, O, and M₂. The spacing L between the fixing members 101a and 101b is thus accurately adjusted in accordance with the width of the “65 (M8) ” U-bolt.

If, for example, the nominal size of the U-bolt 20 is “100 (M10)”, the joint member 103a is provided with the open holes J₁ and J₅, and the joint member 103b is provided with the open holes M₁ and M₅. That is to say, the open holes are provided such that the spacing L between the fixing members 101a and 101b matches the size (width) of the “100 (M10) ” U-bolt. The stop member 104 is inserted into the open holes J₁, K, and M₁, and the stop member 105 is inserted into the open holes J₅, O, and M₅. The spacing L between the fixing members 101a and 101b is thus accurately adjusted in accordance with the width of the “100 (M10) ” U-bolt.

The joint members 103a and 103b have markings corresponding to the nominal size of the U-bolt 20. For example, a marking “65 (M8) ” is given near the open hole J₂ in the joint member 103a and near the open hole M₂ in the joint member 103b. For example, a marking “100 (M10) ” is given near the open hole J₅ in the joint member 103a and near the open hole M₅ in the joint member 103b. These markings being given on the joint members 103a and 103b allow the operator to check, at sight, the position at which the stop member 104 is to be inserted and the position at which the stop member 105 is to be inserted, from both sides of the U-bolt installation jig 100.

Note that the number and the positions of open holes provided in the joint members 103a and 103b, or the positions of the markings given on the joint members 103a and 103b can be adjusted as appropriate in accordance with the size of the U-bolt 20, and are not specifically limited.

The stop member 104 is inserted into the open holes J₁, K, and M₁ to join the fixing member 101a to the joint members 103a and 103b. The stop member 104 is, for example, a metal fitting.

The stop member 105 is inserted into one of the open holes J₂ to Jₙ, the open hole O, and one of the open holes M₂ to Mₙ to join the fixing member 101b to the joint members 103a and 103b. The stop member 105 is, for example, a metal fitting. Note that when the operator inserts the stop member 105, the value of n of the open holes J₂ to Jₙ provided in the joint member 103a needs to be matched with the value of n of the open holes M₂ to Mₙ provided in the joint member 103b.

If, for example, the nominal size of the U-bolt 20 is “65 (M8)”, the stop member 104 is inserted into the open holes J₁, K, and M₁, and the stop member 105 is inserted into the open holes J₂, O, and M₂.

If, for example, the nominal size of the U-bolt 20 is “100 (M10)”, the stop member 104 is inserted into the open holes J₁, K, and M₁, and the stop member 105 is inserted into the open holes J₅, O, and M₅.

It is preferable that the stop member 104 is not pulled out after once being inserted into the open holes J₁, K, and M₁ by the operator. On the other hand, it is preferable that the stop member 105 is inserted into, and pulled out from, one of the open holes J₂ to Jₙ, the open hole O, and one of the M₂ to Mₙ, by the operator. The joint members 103a and 103b are enabled to rotate around the stop member 104 serving as a fulcrum (see an arrow in FIG. 1A), as a result of the stop member 104 being fixed at the open holes J₁, K, and M₁, and the stop member 105 being pulled out from one of the open holes J₂ to Jₙ, the open hole O, and one of the open holes M₂ to Mₙ by the operator. That is to say, the operator can remove the joint members 103a and 103b from the fixing member 101b, and attach the joint members 103a and 103b to the fixing member 101b. As a result, the operator can remove the joint members 103a and 103b from the fixing member 101b and change the spacing L between the fixing members 101a and 101b, as appropriate, in accordance with the size of the U-bolt 20.

The U-bolt installation jig 100 according to the present embodiment includes: the fixing members 101a and 101b that are fixed, with the spacing L between them, to the attachment member 300 while being perpendicular to the attachment member 300, and that are brought into contact with the side portions of the U-bolt 20; the stretchable member 102 that is fitted to the fixing members 101a and 101b while being parallel with the attachment member 300, and that is brought into contact with the center portion of the U-bolt; and the joint members 103a and 103b for finely adjusting the spacing L, the joint members 103a and 103b being joined to the fixing members 101a and 101b and. This configuration enables the U-bolt 20 to be perpendicularly installed onto the attachment member 300 without increasing the number of components.

Further, the U-bolt installation jig 100 according to the present embodiment is capable of adjusting, with high accuracy, the spacing between the fixing members 101a and 101b and the spacing between the attachment member 300 and the stretchable member 102 in accordance with the size of the U-bolt. This configuration enables any type of U-bolt to be perpendicularly installed onto the attachment member 300, allowing the operator to perform U-bolt installation work without taking care of the size of the U-bolt.

<U-Bolt Installation Method>

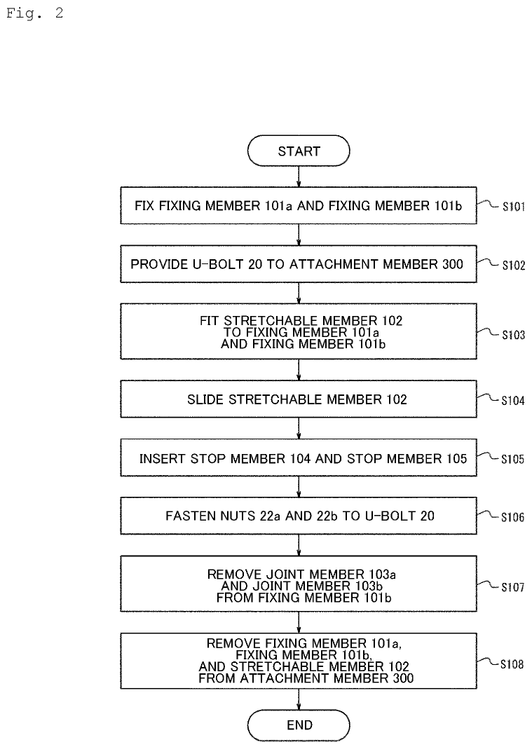

Next, a U-bolt installation method according to the present embodiment will be described with reference to FIGS. 2 to 3G.

In step S101, the operator fixes the fixing members 101a and 101b, with the spacing L between them, to the attachment member 300 such that the fixing members 101a and 101b are perpendicular to the attachment member 300, as shown in FIG. 3A.

In step S102, the operator provides the U-bolt 20 to the attachment member 300 such that the side portions of the U-bolt 20 are brought into contact with the respective fixing members 101a and 101b, as shown in FIG. 3B. At this time, it is preferable that one of the side portions of the U-bolt 20 is fitted into the slide groove Ca provided in the fixing member 101a, and the other one of the side portions of the U-bolt 20 is fitted into the slide groove Cb provided in the fixing member 101b.

In step S103, the operator fits one end of the stretchable member 102 into the slide groove Ca provided in the fixing member 101a, and fits the other end of the stretchable member 102 into the slide groove Cb provided in the fixing member 101b such that the stretchable member 102 is parallel to the attachment member 300, as shown in FIG. 3C. Note that the length of the stretchable member 102 is adjusted in correspondence with the spacing L between the fixing members 102a and 102b.

In step S104, the operator slides the stretchable member 102 in the arrow direction such that the stretchable member 102 comes into contact with the upper portion of the U-bolt 20, as shown in FIG. 3C. The stretchable member 102, one end of which is fitted into the slide groove Ca provided in the fixing member 101a and the other end of which is fitted into the slide groove Cb provided in the fixing member 101b, can smoothly move up and down in the arrow direction along the slide grooves Ca and Cb.

In step S105, the operator inserts the stop member 104 into the open holes J₁, K, and M₁ to join the fixing member 101a to the joint members 103a and 103b, as shown in FIG. 3D. The operator also inserts the stop member 105 to one of the open holes J₂ to Jₙ, the open holes 0, and one of the open hole holes M₂ to Mₙ, to join the fixing member 101b to the joint members 103a and 103b. If, for example, the nominal size of the U-bolt 20 is “100 (M10)”, the operator inserts the stop member 104 into the open holes J₁, K, and M₁, and inserts the stop member 105 into the open holes J₅, O, and M₅.

In step S106, the operator fastens a nut 22a to one end portion of the U-bolt 20 from a surface S₁ and an opposite surface S₂ of the attachment member 300 via a washer 21a, as shown in FIG. 3E. The operator also fastens a nut 22b to the other end portion of the U-bolt 20 from the surface S₁ and the opposite surface S₂ of the attachment member 300 via a washer 21b. The conduit 10 is thus fixed to the attachment member 300.

The operator can perpendicularly install the U-bolt 20 to the attachment member 300 without increasing the number of components by performing processing in the above-described steps S101 to S106.

In step S107, the operator pulls out the stop member 105 from the one of the open holes J₂ to Jₙ, the open hole O, and the one of the open holes M₂ to Mₙ, as shown in FIG. 3F. The joint members 103a and 103b are thus removed from the fixing member 101b. If, for example, the nominal size of the U-bolt 20 is “100 (M10)”, the operator pulls out the stop member 105 from the open holes J₅, O, and M₅.

In step S108, the operator removes, from the attachment member 300, the fixing members 101a joined to the joint members 103a and 103b, the fixing member 101b, and the stretchable member 102, as shown in FIG. 3G.

The U-bolt installation method according to the present embodiment includes the above-described steps S101 to S108. This method enables the U-bolt 20 to be perpendicularly installed onto the attachment member 300 without increasing the number of components.

<Variation 1>

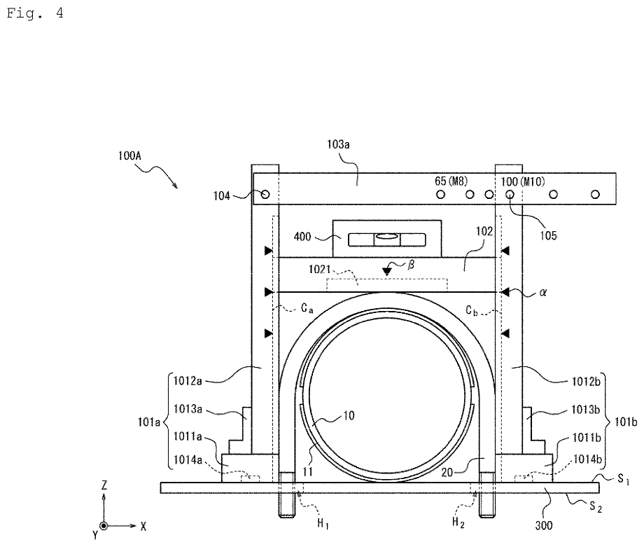

Next, a U-bolt installation jig 100A according to the variation 1 will be described with reference to FIG. 4.

The U-bolt installation jig 100A according to the variation 1 is different from the U-bolt installation jig 100 according to the embodiment in that the U-bolt installation jig 100 according to the embodiment does not have a spirit level, and the fixing members 101a and 101b and the stretchable member 102 do not have markings, whereas the U-bolt installation jig 100A according to the variation 1 has a spirit level, and the fixing members 101a and 101b and the stretchable member 102 have markings. Note that the other configurations are the same as those of the U-bolt installation jig 100 according to the embodiment, and therefore, redundant description is omitted.

The fixing members 101a and 101b have markings a for keeping the stretchable member 102 horizontal with respect to the attachment member 300. The fixing members 101a and 101b having the markings a enable the stretchable member 102 to be stably kept horizontal with respect to the attachment member 300.

The stretchable member 102 have a marking β for keeping the U-bolt 20 perpendicular to the attachment member 300. The stretchable member 102 having the marking β enables the U-bolt 20 to be stably kept perpendicular to the attachment member 300.

A spirit level 400 is placed on the stretchable member 102 and detects the inclination of the U-bolt 20 with respect to the attachment member 300. The operator finely adjusts the position of the stretchable member 102, while observing the spirit level 400, such that the stretchable member 102 is horizontal with respect to the attachment member 300. This configuration can further increase the installation accuracy of the U-bolt 20.

The U-bolt installation jig 100A according to the variation 1 enables the U-bolt 20 to be perpendicularly installed onto the attachment member 300 without increasing the number of components.

<Variation 2>

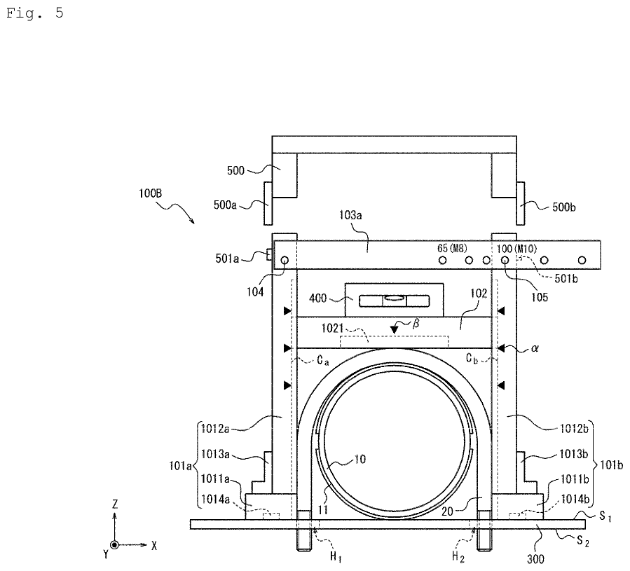

Next, a U-bolt installation jig 100B according to the variation 2 will be described with reference to FIG. 5.

The U-bolt installation jig 100B according to the variation 2 is different from the U-bolt installation jig 100A according to the variation 1 in that the U-bolt installation jig 100A according to the variation 1 does not have a handle, whereas the U-bolt installation jig 100B according to the variation 2 has a handle. Note that the other configurations are the same as the U-bolt installation jig 100A according to the variation 1, and therefore, redundant description is omitted.

A handle 500 is attached to the fixing members 101a and 101b. The handle 500 includes fastening portions 500a and 500b. The fixing members 101a and 101b include respective fastened portions 501a and 501b. The handle 500 is attached to the fixing members 101a and 101b as a result of the fastening portions 500a and 500b provided in the handle 500 being joined to the fastened portions 501a and 501b provided in the fixing members 101a and 101b. The handle 500 is capable of rotating around fulcrums that are joint portions at which the fastening portions 500a and 500b are joined to the fastened portions 501a and 501b.

The fastening portions 500a and 500b may be, for example, hooks or magnets, and their configuration is not specifically limited.

The fastened portions 501a and 501b may be, for example, hook stops or magnets, and their configuration is not specifically limited.

It is preferable that the handle 500 has a shape that is easy for the operator to hold by hand. For example, the handle 500 is a bar-shaped member. The handle 500 being attached to the fixing members 101a and 101b allows the operator to easily carry the U-bolt installation jig 100B, and can improve the workability when the operator installs the U-bolt 20.

The U-bolt installation jig 100B according to the variation 2 enables the U-bolt 20 to be perpendicularly installed onto the attachment member 300 without increasing the number of components.

Although the above embodiment has been described as a representative example, it is apparent to those skilled in the art that many changes and substitutions can be made within the gist and scope of the disclosure. Accordingly, the present invention should not be construed as being limited by the above embodiment, and various variations and changes may be made without departing from the claims. More than one steps described in the flowchart of the embodiment may be combined into one step, or one step may be divided into more than one steps.

### REFERENCE SIGNS LIST

10 Conduit
11 Protective piece
20 U-bolt
21a Washer
21b Washer
22a Nut
22b Nut
100 U-bolt installation jig
100A U-bolt installation jig
100B U-bolt installation jig
101a Fixing member (first fixing member)
101b Fixing member (second fixing member)
102 Stretchable member
103a Joint member (first joint member)
103b Joint member (second joint member)
104 Stop member (first stop member)
105 Stop member (second stop member)
300 Attachment member
400 Spirit level
500 Handle
500a Fastening portion
500b Fastening portion
501a Fastened portion
501b Fastened portion
1011a Fixing portion
1012a Branch portion
1013a Reinforcing portion
1014a Magnet
1011b Fixing portion
1012b Branch portion
1013b Reinforcing portion
1014b Magnet
1021 Magnet

1. A U-bolt installation jig for installing a U-bolt for fixing a conduit to a member, the jig comprising:
a first fixing member and a second fixing member opposing each other with a predetermined spacing therebetween while being perpendicular to the member, the first and second fixing members being brought into contact with side portions of the U-bolt;
a stretchable member fitted to the first fixing member and the second fixing member while being parallel to the member, the stretchable member being brought into contact with a center portion of the U-bolt; and
a first joint member and a second joint member joined to the first fixing member and the second fixing member, the first and second joint members sandwiching the first fixing member and the second fixing member to finely adjust the predetermined spacing.

2. The U-bolt installation jig according to claim 1, further comprising:
a first stop member inserted into an open hole provided in the first fixing member, an open hole provided on a first end side of the first joint member, and an open hole provided on the first end side of the second joint member to join the first fixing member to the first joint member and the second joint member; and
a second stop member inserted into an open hole provided in the second fixing member, an open hole provided on a second end side of the first joint member, and an open hole provided on the second end side of the second joint member to join the second fixing member to the first joint member and the second joint member.

3. The U-bolt installation jig according to claim 1, wherein
the first fixing member, the second fixing member, and the stretchable member each having an internally embedded magnet.

4. The U-bolt installation jig according to any onc of claim 1, wherein
the first joint member and the second joint member each have a making corresponding to a nominal size of the U-bolt.

5. The U-bolt installation jig according to claim 1 further comprising:
a spirit level for detecting an inclination of the stretchable member with respect to the member.

6. The U-bolt installation jig according to claim 1 wherein
the first fixing member and the second fixing member each have a marking for keeping the stretchable member horizontal with respect to the member, and
the stretchable member has a marking for keeping the U-bolt perpendicular to the member.

7. The U-bolt installation jig according to claim 1 further comprising:
a handle attached to the first fixing member and the second fixing member.

8. A U-bolt installation method for installing a U-bolt for fixing a conduit to a member, the method comprising:
fixing a first fixing member and a second fixing member, with a predetermined spacing therebetween, to the member such that the first fixing member and the second fixing member are perpendicular to the member;
providing the U-bolt to the member such that side portions of the U-bolt come into contact with the first fixing member and the second fixing member;
fitting a stretchable member to the first fixing member and the second fixing member such that the stretchable member is parallel to the member;
sliding the stretchable member such that the stretchable member comes into contact with a center portion of the U-bolt;
joining a first joint member and a second joint member to the first fixing member and the second fixing member and finely adjusting the predetermined spacing;
fastening a nut to the U-bolt;
removing the first joint member and the second joint member from the second fixing member; and
removing the first fixing member joined to the first joint member and the second joint member, the second fixing member, and the stretchable member from the member.

9. The U-bolt installation jig according to claim 2, wherein
the first fixing member, the second fixing member, and the stretchable member each having an internally embedded magnet.

10. The U-bolt installation jig according to claim 2, wherein
the first joint member and the second joint member each have a making corresponding to a nominal size of the U-bolt.

11. The U-bolt installation jig according to claim 2, further comprising:
a spirit level for detecting an inclination of the stretchable member with respect to the member.

12. The U-bolt installation jig according to claim 2, wherein
the first fixing member and the second fixing member each have a marking for keeping the stretchable member horizontal with respect to the member, and
the stretchable member has a marking for keeping the U-bolt perpendicular to the member.

13. The U-bolt installation jig according to claim 2, further comprising:
a handle attached to the first fixing member and the second fixing member.

14. The U-bolt installation method according to claim 8, the method further comprising:
inserting a first stop member into an open hole provided in the first fixing member, an open hole provided on a first end side of the first joint member, and an open hole provided on the first end side of the second joint member to join the first fixing member to the first joint member and the second joint member; and
inserting a second stop member into an open hole provided in the second fixing member, an open hole provided on a second end side of the first joint member, and an open hole provided on the second end side of the second joint member to join the second fixing member to the first joint member and the second joint member.

15. The U-bolt installation method according to claim 8, wherein
the first fixing member, the second fixing member, and the stretchable member each having an internally embedded magnet.

16. The U-bolt installation method according to claim 8, wherein
the first joint member and the second joint member each have a making corresponding to a nominal size of the U-bolt.

17. The U-bolt installation method according to claim 8, further comprising:
a spirit level for detecting an inclination of the stretchable member with respect to the member.

18. The U-bolt installation method according to claim 8, wherein
the first fixing member and the second fixing member each have a marking for keeping the stretchable member horizontal with respect to the member, and
the stretchable member has a marking for keeping the U-bolt perpendicular to the member.

19. The U-bolt installation method according to claim 8, further comprising:
a handle attached to the first fixing member and the second fixing member.

20. The U-bolt installation method according to claim 14, the first fixing member, the second fixing member, and the stretchable member each having an internally embedded magnet.
